(19) United States
(12) Patent Application Publication
(10) Pub. No.: US 2015/0109683 A1
(43) Pub. Date: Apr. 23, 2015

(54) LENS SYSTEM, LENS BARREL, AND DRIVE UNIT

(71) Applicant: FUJIFILM Corporation, Tokyo (JP)

(72) Inventor: Tsuyoshi MITARAI, Saitama (JP)

(21) Appl. No.: 14/580,962

(22) Filed: Dec. 23, 2014

Related U.S. Application Data
(63) Continuation of application No. PCT/JP2013/072957, filed on Aug. 28, 2013.

(30) Foreign Application Priority Data
Aug. 31, 2012 (JP) 2012-190739

(51) Int. Cl. G02B 7/10

(52) U.S. Cl. CPC G02B 7/10
USPC 359/696; 359/701

(57) ABSTRACT

An object is to provide a lens system that can change the magnitude of torque required to rotate an operation ring according to the attachment/detachment of a drive unit to/from a lens barrel, the lens barrel, and the drive unit. When the drive unit is not mounted on the lens barrel, a torque adjustment mechanism works and a friction member presses the operation ring by a biasing force of a biasing member. When the drive unit is mounted on the lens barrel, a release member provided on the drive unit releases a bias, which is performed by the biasing member, by acting on the torque adjustment mechanism through a passage formed in a fixed ring.

### CROSS-REFERENCE TO RELATED APPLICATIONS

This application is a Continuation of PCT International Application No. PCT/JP2013/072957 filed on Aug. 28, 2013, which claims priority under 35 U.S.C. §119(a) to Japanese Patent Application No. 2012-190739 filed on Aug. 31, 2012. Each of the above application(s) is hereby expressly incorporated by reference, in its entirety, into the present application.

### BACKGROUND OF THE INVENTION

1. Field of the Invention

The present invention relates to a lens system, a lens barrel, and a drive unit.

2. Description of the Related Art

Optical systems, such as a zoom lens, a focus lens, and an iris, are built in a lens barrel of a movie camera, or the like. Operation rings, such as a zoom ring, a focus ring, and an iris ring, are rotatably provided on the outer peripheral surface of the lens barrel. When the operation rings are manually operated, the positions of the optical systems (the zoom lens and the like) corresponding to the operation rings are adjusted.

Meanwhile, a drive unit, which electrically drives an operation ring, is mounted on a lens barrel of a broadcasting camera, and a cameraman adjusts an optical system by rotating the operation ring through the operation of the drive unit. There are also a lens barrel on which a drive unit can be detachably mounted and the drive unit so that a camera is used for both a movie and broadcasting. Since an operation ring is rotated by hand when the drive unit is not mounted, it is desirable that torque required to rotate the operation ring be relatively large. It is preferable that the operation ring not move due to only contact by mistake. Meanwhile, when the drive unit is mounted, it is preferable that torque required to rotate the operation ring be small for the reduction in power consumption.

JP2001-147362A discloses a structure that allows a friction member to come into contact with an operation ring to prevent the position of an optical system from being changed by the weight of a lens, but there is provided a switching switch for switching a position where the friction member works and a position where the friction member is released. The structure disclosed in JP2001-147362A is not provided with a drive unit.

A lens barrel disclosed in JP2009-276468A switches a load, which is applied to an operation ring, by motor driving and manual driving while a drive unit is mounted on the lens barrel. A load applied to the operation ring is given using frictional resistance, but a technical object that torque required to rotate the operation ring is not changed according to the attachment/detachment of the drive unit is not provided.

### SUMMARY OF THE INVENTION

An object of the invention is to change the magnitude of torque, which is required to rotate an operation ring, according to the attachment/detachment of a drive unit to/from a lens barrel.

More particularly, an object of the invention is to change torque required to rotate an operation ring so that the torque is relatively reduced when a drive unit is mounted on a lens barrel and the torque is relatively increased when a drive unit is detached.

A lens system according to the invention includes a lens barrel on which an operation ring used to adjust an optical system provided in the lens barrel is rotatably provided, and a drive unit that is detachably mounted on the lens barrel and rotates the operation ring when being mounted on the lens barrel.

The lens barrel includes a lens barrel body in which the optical system is built, the operation ring that is provided on an outer peripheral side of the lens barrel body, a fixed ring that is disposed and fixed to the outer peripheral side of the lens barrel body and guides the rotation of the operation ring, and a torque adjustment mechanism that is provided in a space between an outer peripheral surface of the lens barrel body and a part of the operation ring and the fixed ring.

The torque adjustment mechanism includes a friction member, a holding member that is provided on the fixed ring and holds the friction member so that the friction member freely approaches or is freely separated from the operation ring or a member interlocking with the operation ring, and a biasing member that biases the friction member in a direction where the friction member comes into contact with the operation ring or a member interlocking with the operation ring.

A passage, which communicates with the torque adjustment mechanism from the outside, is formed in the fixed ring.

The drive unit includes a release member that separates the friction member from the operation ring or the member interlocking with the operation ring by acting on the torque adjustment mechanism through the passage when the drive unit is mounted on the lens barrel.

When the drive unit is not mounted on the lens barrel, the torque adjustment mechanism works and the friction member comes into contact with and presses the operation ring or the member interlocking with the operation ring by a biasing force of the biasing member. Accordingly, a frictional force of the friction member acts on the operation ring. For this reason, torque required to rotate the operation ring is relatively large.

When the drive unit is mounted on the lens barrel, the release member provided on the drive unit releases a bias, which is performed by the biasing member, by acting on the torque adjustment mechanism through the passage formed in the fixed ring. Accordingly, the friction member is separated from the operation ring or the member interlocking with the operation ring, so that a frictional force is not applied. Torque required to rotate the operation ring is relatively reduced.

As described above, according to the invention, it is possible to change the magnitude of torque required to rotate the operation ring according to the attachment/detachment of the drive unit to/from the lens barrel.

The invention also provides the lens barrel that forms the lens system.

An operation ring used to adjust an optical system provided on a lens barrel is rotatably provided on the lens barrel according to the invention. The lens barrel includes a lens barrel body in which the optical system is built, the operation ring that is provided on an outer peripheral side of the lens barrel body, a fixed ring that is disposed and fixed to the outer peripheral side of the lens barrel body and guides the rotation of the operation ring, and a torque adjustment mechanism that is provided in a space between an outer peripheral surface of the lens barrel body and a part of the operation ring and the fixed ring. The torque adjustment mechanism includes a friction member, a holding member that is provided on the fixed ring and holds the friction member so that the friction member freely approaches or is freely separated from the operation ring or a member interlocking with the operation ring, and a biasing member that biases the friction member in a direction where the friction member comes into contact with the operation ring or the member interlocking with the operation ring. Further, a passage, through which a release member provided on the drive unit acts on the torque adjustment mechanism when a drive unit is mounted on the lens barrel, is formed in the fixed ring.

In the lens barrel, the friction member comes into contact with and presses the operation ring or the member interlocking with the operation ring by the work of the torque adjustment mechanism. For this reason, since the frictional force of the friction member is applied, torque required to rotate the operation ring is relatively large.

The invention provides a drive unit that is suitable for the lens barrel. The drive unit is detachably mounted on the lens barrel, and includes a drive that rotates the operation ring when the drive unit is mounted on the lens barrel and the release member that acts on the torque adjustment mechanism through the passage.

Accordingly, when the drive unit according to the invention is mounted on the lens barrel, the release member releases the bias of the friction member, which is performed by the biasing member, by acting on the torque adjustment mechanism through the passage formed in the fixed ring of the lens barrel. Accordingly, a frictional force, which is caused by the friction member, is not applied to the operation ring or the member interlocking with the operation ring. As a result, torque required to rotate the operation ring is relatively reduced.

In the embodiment of the invention, the release member acts on the holding member or the biasing member of the torque adjustment mechanism.

In one embodiment of the torque adjustment mechanism, the holding member and the biasing member are formed by one leaf spring. In another embodiment, the holding member is a link member of which a part is rotatably supported, the friction member is provided at one end portion of the link member, and the other portion of the link member is pulled or pushed by the biasing member, so that the friction member comes into contact with and presses the operation ring or the member interlocking with the operation ring. In still another embodiment, the holding member and the biasing member are formed by a combination of a first support member that is fixed to the fixed ring, a rectangular parallelepiped elastic body that is fixed to the first support member, and a second support member that is fixed to the elastic body, and the friction member is mounted on the second support member.

As described above, it is possible to change the magnitude of torque required to rotate an operation ring according to the attachment/detachment of a drive unit to/from a lens barrel. Further specific embodiments of the invention will become more apparent in the description of an example with reference to the following drawings.

### BRIEF DESCRIPTION OF THE DRAWINGS

FIG. 1 is a perspective view of a lens barrel on which a drive unit is mounted.

FIG. 2 is a cross-sectional view of the lens barrel on which the drive unit is not mounted.

FIG. 3 is a cross-sectional view of the lens barrel on which the drive unit is mounted.

FIG. 4 is a view showing a modification of a torque adjustment mechanism and is a cross-sectional view of the lens barrel on which the drive unit is not mounted.

FIG. 5 is a view showing the modification of the torque adjustment mechanism and is a cross-sectional view of the lens barrel on which the drive unit is not mounted.

FIG. 6 is a view showing another modification of the torque adjustment mechanism and is a cross-sectional view of the lens barrel on which the drive unit is not mounted.

FIG. 7 is a view showing another modification of the torque adjustment mechanism and is a cross-sectional view of the lens barrel on which the drive unit is mounted.

FIG. 8 is a view showing a still another modification of the torque adjustment mechanism and shows a state in which the drive unit is not mounted.

### DESCRIPTION OF THE PREFERRED EMBODIMENTS

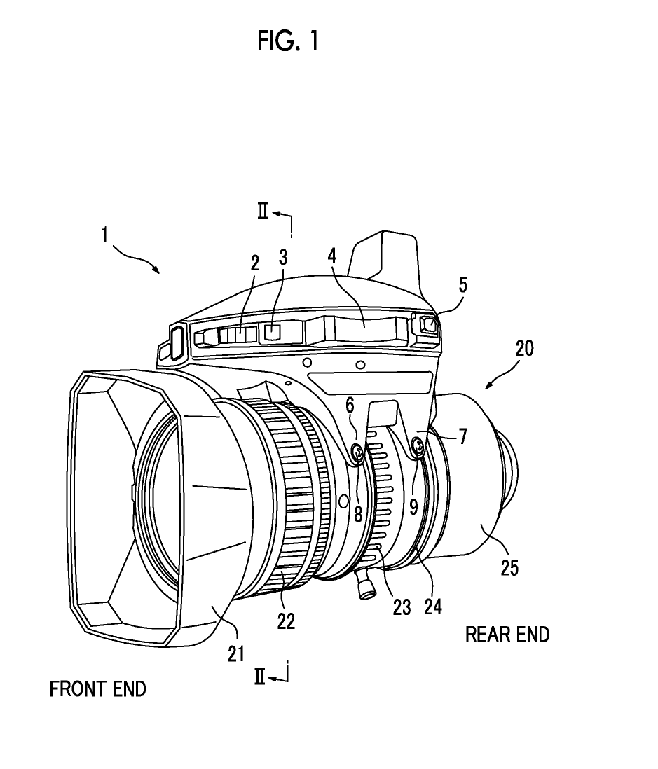

FIG. 1 is a perspective view of a lens barrel 20 (a lens system), and shows a state in which a drive unit 1 driving a zoom lens or the like built in the lens barrel 20 is mounted.

A focus ring 22, a zoom ring 23, and an iris ring 24 are rotatably provided on the outer peripheral surface of the lens barrel 20 in this order from a front end side toward a rear end side. A lens cover 21 is mounted on the front end portion of the lens barrel 20. A mount portion 25, which is mounted on a camera body (not shown), is formed at the rear end portion of the lens barrel 20.

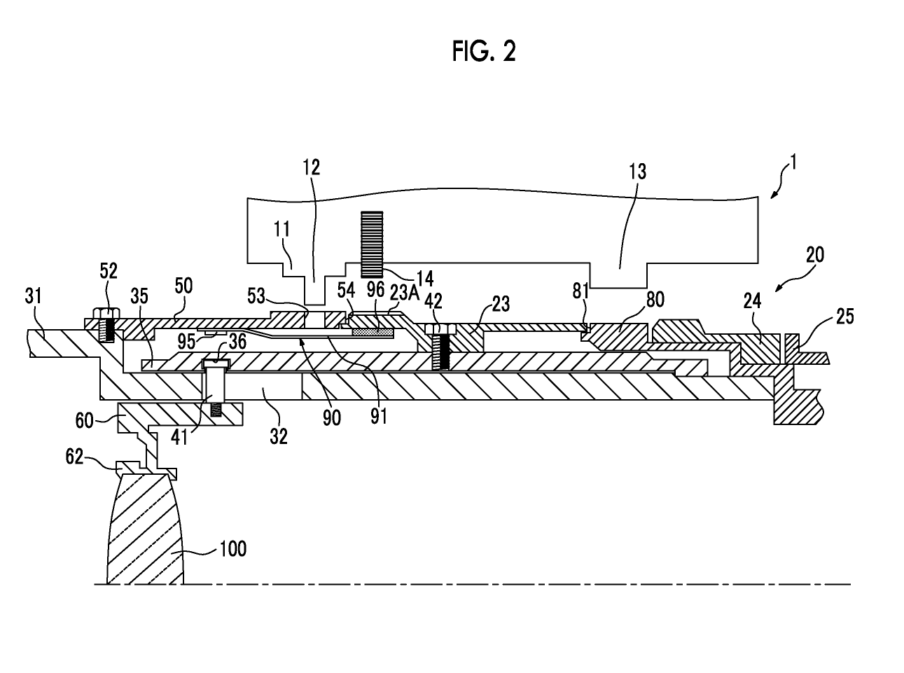

An optical system (an imaging lens), such as a focus lens (not shown), a zoom lens (of which one example is denoted in FIG. 2 and the like by reference numeral 100), and an iris (not shown), is held in the lens barrel 20. When a user manually rotates the focus ring 22 (when the drive unit 1 is not mounted) or rotates the focus ring 22 by using the drive unit 1 that is mounted on the lens barrel 20, the focus lens moves in a direction of an optical axis. When a user manually rotates the zoom ring 23 or rotates the zoom ring 23 by using the drive unit 1, the zoom lens moves in the direction of the optical axis. Further, when the iris ring 24 is rotated, the aperture diameter is changed (the adjustment of the optical system).

An iris mode switching switch 2, an automatic switch 3, a zoom seesaw switch 4, and a return switch 5, which are operated by a user, are provided on the side surface of the drive unit 1. The iris mode switching switch 2 is a switch used to switch a mode to a mode in which the adjustment of the iris is automatically performed and a manual mode in which the adjustment of the iris is manually performed. The automatic switch 3 is a switch that is used to temporarily switch a mode to the automatic mode when the adjustment of the iris is performed in the manual mode. The zoom seesaw switch 4 is a switch that is used to give a command for moving the position of the zoom lens by rotating the zoom ring 23 by the drive unit 1. The return switch 5 is a switch that is used to switch an image displayed on a view finder (not shown). In addition, a focus switch (not shown) that is used to rotate the focus ring 22 by the drive unit 1 and an iris switch (not shown) that is used to rotate the iris ring 24 are provided at the rear end portion of the drive unit 1.

Mounting legs 6 and 7 are formed at four positions on the drive unit 1 (only two mounting legs 6 and 7 are shown in FIG. 1, and the other two mounting legs are not shown). Holes are formed at these mounting legs 6 and 7 and fixing screws 8 and 9 pass through these holes and are screwed into screw holes formed at a barrel body of the lens barrel 20 (a portion of the lens barrel 20 except for the rings 22, 23, and 24), so that the drive unit 1 is mounted on the lens barrel 20. When these screws 8 and 9 are removed, the drive unit 1 is detached from the lens barrel 20.

FIG. 2 is a cross-sectional view including the optical axis and as seen from the side a cross section cut in the vertical direction (corresponding to a cross-sectional view taken along line II-II) of a portion that is necessary for the description of the lens barrel 20 (particularly, a mechanism for moving the zoom lens). The upward direction in the vertical direction is the direction of the side on which the drive unit 1 is installed and the downward direction is the opposite direction of the upward direction. The drive unit 1 is detached from the lens barrel 20, and the appearance of the drive unit 1 is schematically shown.

The basic structure of the lens barrel 20 is a cylindrical lens barrel body 31. A cylindrical cam barrel 35 is rotatably fitted to the outer peripheral surface of the lens barrel body 31. The zoom ring 23 is provided on the outside (outer periphery) of the cam barrel 35, and the zoom ring 23 and the cam barrel 35 are integrally fixed to each other by a screw 42. When the zoom ring 23 is rotated, the cam barrel 35 is also rotated. A spiral cam groove 36 is formed on the inner peripheral surface of the front end portion of the cam barrel 35, and the head of a cam pin 41 is movably fitted to the cam groove 36. Meanwhile, the zoom lens 100 (only one of a zoom lens group is shown) is held on an annular moving frame 60 by a holding member 62 that is integrated with the moving frame 60. The moving frame 60 is movable in the lens barrel body 31 in the axial direction of the lens barrel body 31. The cam pin 41 stands on the moving frame 60 in a radial direction. The cam pin 41 passes through a long hole (guide hole) 32, which is formed in the lens barrel body 31 along the axial direction, so as to be movable in the long hole. A groove, a long hole, and a cam pin, which are the same as the spiral groove 36 of the cam barrel 35, the long hole 32 of the lens barrel body 31, and the cam pin 41, are also provided at positions that are point-symmetric with respect to the center axis of the lens barrel body 31 (on the opposite side corresponding to a phase difference of) 180°. When the zoom ring 23 is rotated by the above-mentioned mechanism, the cam barrel 35 is rotated and the cam pin 41 moves in the axial direction that is restricted by the spiral groove 36 and the long hole 32. Accordingly, the zoom lens 100 moves in the axial direction.

Fixed rings 50 and 80 are fixed to the outer periphery of the lens barrel body 31 at positions on both sides of the zoom ring 23. A screw, which is used to fix the fixed ring 50, is denoted by reference numeral 52. Annular stepped portions 54 and 81 are formed at end edges of the fixed rings 50 and 80, which respectively come into contact with the zoom ring 23. The zoom ring 23 is fitted to the annular stepped portions, so that the annular stepped portions guide the rotation of the zoom ring 23 (the zoom ring 23 does not move in the axial direction). Teeth (gear) 23A are formed on a part of the peripheral surface of the zoom ring 23. When the drive unit 1 is mounted on the lens barrel 20, a driving gear 14, which is rotationally driven by a motor (not shown) provided in the drive unit 1, meshes with the teeth 23A. Accordingly, the zoom ring 23 is electrically driven. Meanwhile, the iris ring 24 is rotatably provided between the fixed ring 80 and the mount portion 25.

A small annular space is formed between the fixed ring 50 and the cam barrel 35 and between a portion of the zoom ring 23 corresponding to the inner peripheral side of the teeth 23A and the cam barrel 35. A torque adjustment mechanism 90 is provided at a position in the space that corresponds to a position at which the drive unit 1 is mounted. The torque adjustment mechanism 90 includes a leaf spring 91 and a friction member 96. One end of the leaf spring 91 is fixed to the inner peripheral surface of the fixed ring 50 by a pin 95, the leaf spring 91 is slightly bent toward the lens barrel body 31 and extends to the inner peripheral side of the zoom ring (the inside of a portion of the zoom ring where the teeth 23A is formed), and the friction member 96 is fixed to the other end of the leaf spring 91. The friction member 96 has only to generate sliding friction having appropriate magnitude in consideration of a biasing force of rubber (elastic body), a synthetic resin, or the other leaf spring 91. The friction member 96 comes into contact with the inner surface of the zoom ring 23 due to the spring force (biasing force) of the leaf spring 91, and slightly presses the inner surface (a state shown in FIG. 2). The leaf spring 91 has functions of the holding member and the biasing member for the friction member 96.

Since the friction member 96 comes into contact with the inner surface of the zoom ring 23 due to the force of the leaf spring 91 and slightly presses the inner surface of the zoom ring 23 when the drive unit 1 is not mounted on the lens barrel 20, a frictional force acts. For this reason, torque required to rotate the zoom ring 23 is relatively large.

A hole 53, which serves as a passage through which a release member passes, is formed at a portion of the fixed ring 50 that exactly corresponds to the leaf spring 91. This passage is not limited to a hole and may be a notch. Further, the shape of a hole or a notch may be a desired shape, such as a circular shape, a quadrangular shape, or a U shape.

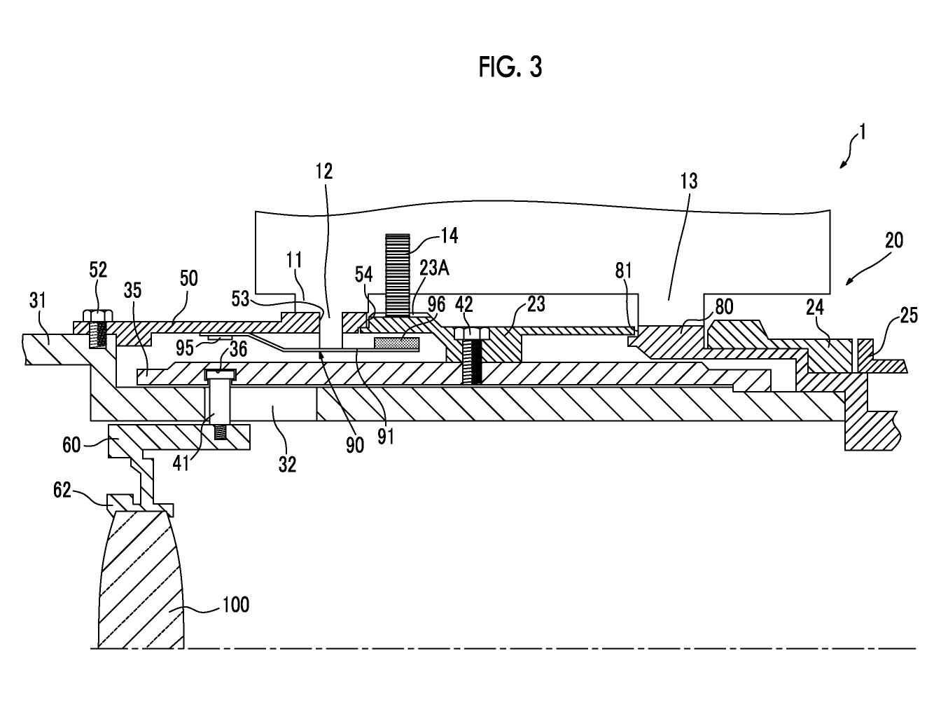

Meanwhile, protrusions 11 and 13 are formed at the drive unit 1 so that the drive unit 1 comes into close contact with the lens barrel 20. When the drive unit 1 is mounted on the lens barrel 20 as shown in FIG. 3, these protrusions 11 and 13 come into contact with the surfaces of the fixed rings 50 and 80. One protrusion 11 is further provided with a release member 12 that protrudes outward. The release member 12 enters the lens barrel 20 through the passage 53 and pushes the leaf spring 91 to the inside when the drive unit 1 is mounted. Accordingly, the friction member 96 fixed to the leaf spring 91 is separated from the inner surface of the zoom ring 23. Since a frictional force does not act by the friction member 96, torque required to rotate the zoom ring 23 is relatively reduced.

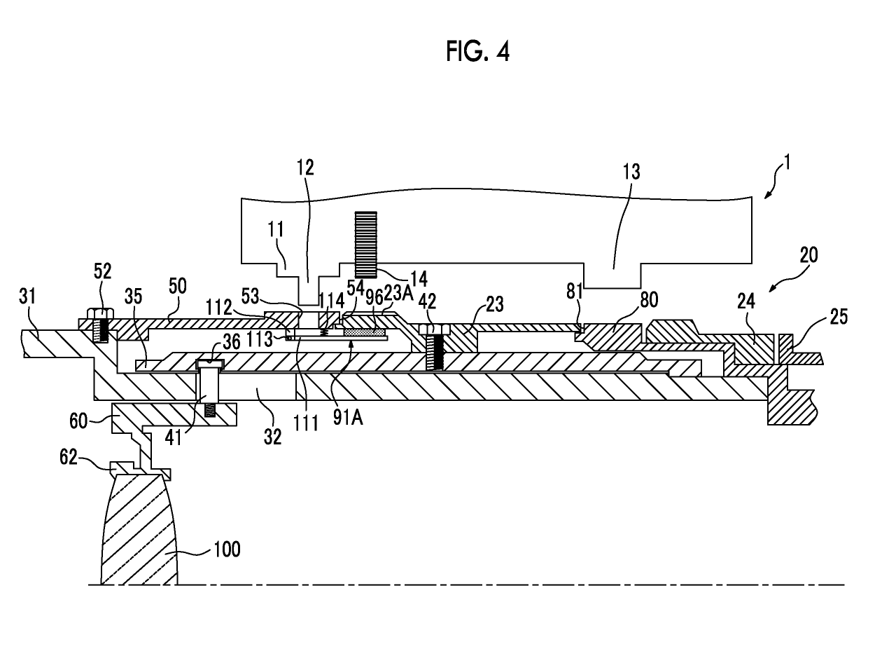

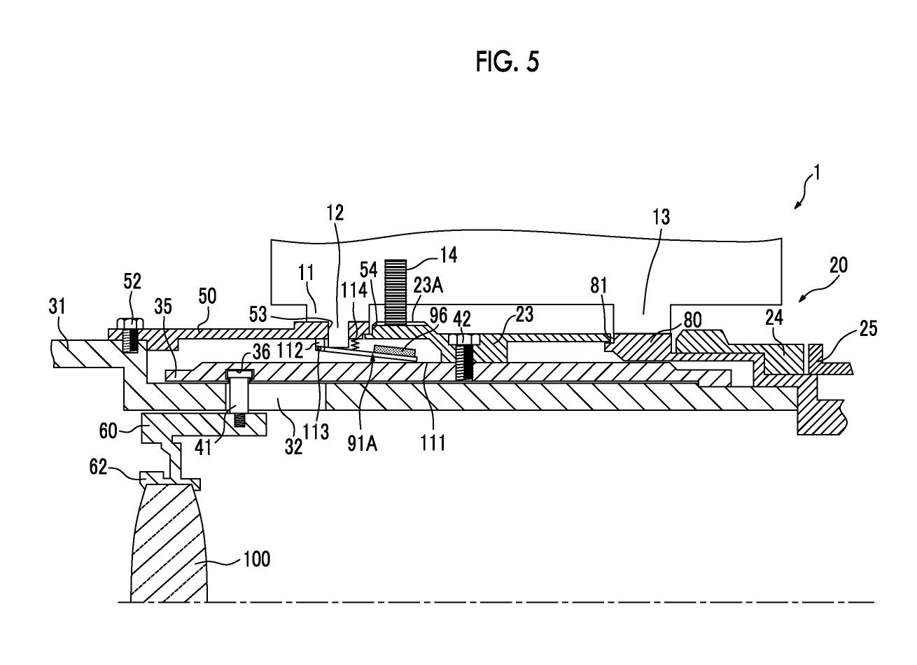

FIGS. 4 and 5 show a modification of the torque adjustment mechanism. The same members as the members shown in FIGS. 2 and 3 are denoted by the same reference numerals, and the repeated description thereof will be omitted. The same is true in other modifications to be described below.

In FIG. 4, a torque adjustment mechanism 91A includes a link member 111. One end of the link member 111 is rotatably mounted on a support arm 112, which is provided on the inner surface of the fixed ring 50, by a pin 113. A friction member 96 is fixed to the other end of the link member 111. The link member 111 is also biased in a direction, in which the friction member 96 comes into contact with the inner surface of the zoom ring 23, by a pull spring 114 that is mounted on the inner surface of the fixed ring 50. Accordingly, a force required to rotate the zoom ring 23 is relatively large.

When the drive unit 1 is mounted on the lens barrel 20 as shown in FIG. 5, the release member 12 enters the lens barrel 20 through the passage 53 and pushes the link member 111 to the inside. Accordingly, since the friction member 96 is separated from the inner surface of the zoom ring 23, torque required to rotate the zoom ring 23 is reduced.

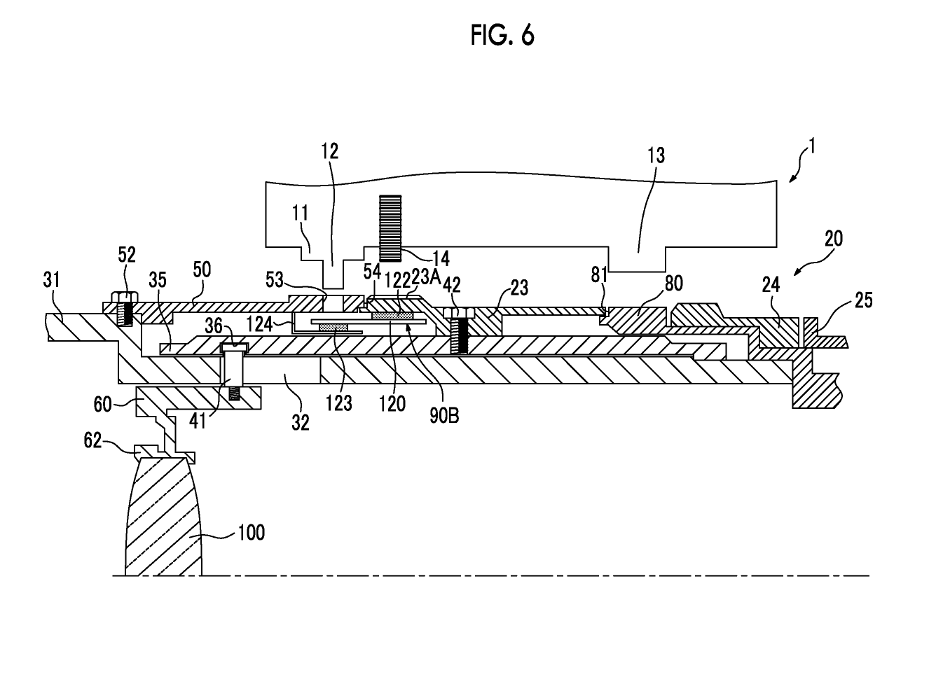

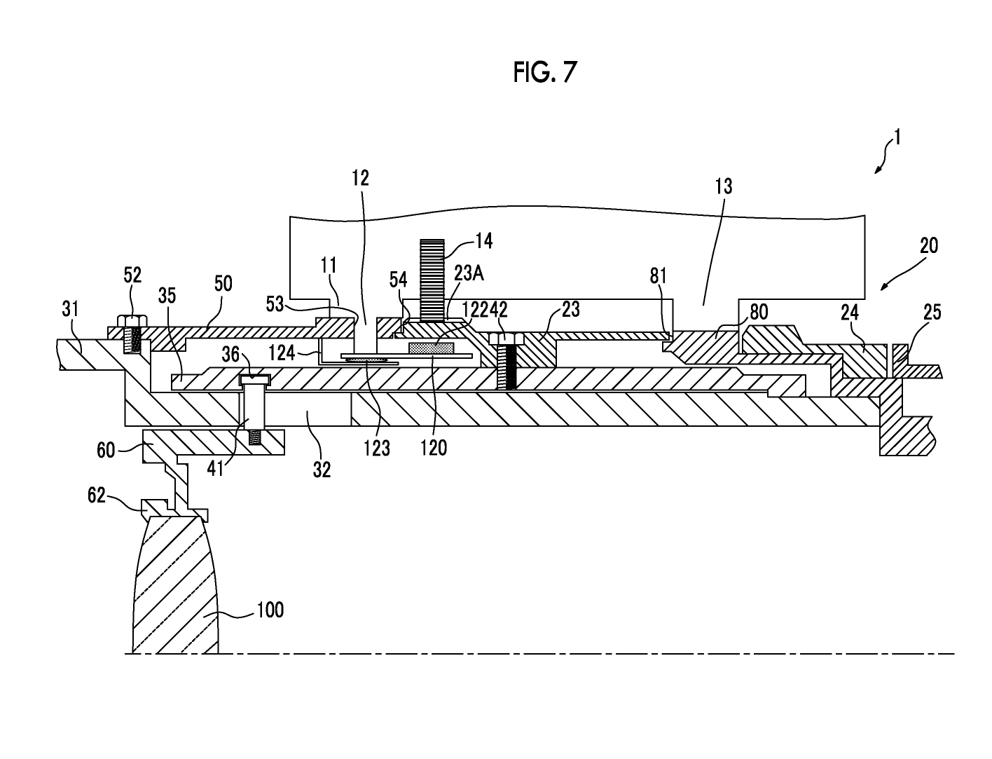

FIGS. 6 and 7 show a still another modification of the torque adjustment mechanism.

An L-shaped support member (first support member) 124 is fixed to the inner peripheral surface of the fixed ring 50. The support member 124 extends in a direction of the passage 53, and a support plate 120 (second support member) is fixed to the surface of the support member 124 through a rectangular parallelepiped elastic body 123 (for example, rubber) at a position exactly corresponding to the passage 53. A friction member 122, which comes into contact with the inner peripheral surface of the zoom ring 23, is fixed to the front end portion of the support plate 120.

When the drive unit 1 is not mounted on the lens barrel 20 as shown in FIG. 6, the support plate 120 is pushed toward the zoom ring 23 by an elastic force of the elastic body 123 and the friction member 122 comes into contact with the inner peripheral surface of the zoom ring 23. For this reason, torque required to rotate the zoom ring 23 is relatively large.

In contrast, since the elastic body 123 is crushed (compressed) by the release member of the drive unit 1 when the drive unit 1 is mounted on the lens barrel 20 as shown in FIG. 7, the support plate 120 is displaced toward the center of the lens barrel 20. Accordingly, the friction member 122 having come into contact with the inner peripheral surface of the zoom ring 23 is separated from the inner peripheral surface of the zoom ring 23, so that torque required to rotate the zoom ring 23 is reduced.

As described above, it is possible to relatively increase torque required to rotate the zoom ring 23 when the drive unit 1 is not mounted on the lens barrel 20, and to reduce torque required to rotate the zoom ring 23 when the drive unit 1 is mounted on the lens barrel 20.

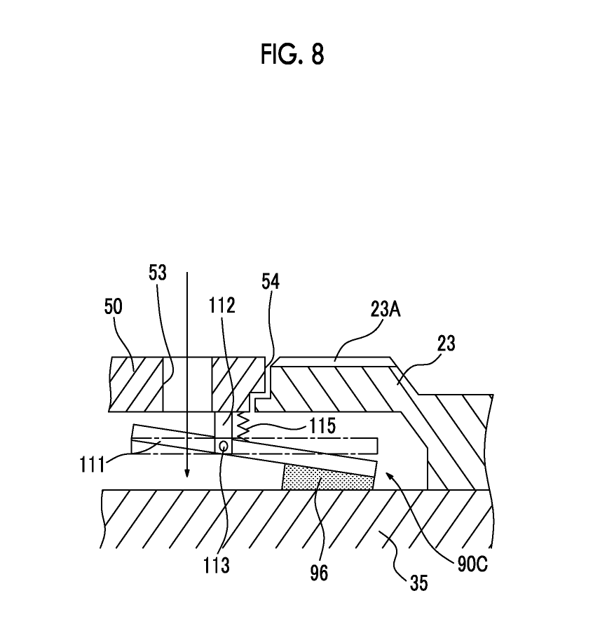

FIG. 8 is a view showing a still another modification of the torque adjustment mechanism. In a torque adjustment mechanism 90C, a link member 111 is rotatably mounted on a substantially middle of a support arm 112, which is fixed to the inner surface of the fixed ring 50, by a pin 113. One end portion of the link member 111 extends to a position corresponding to the passage 53, and a friction member 96 is fixed to the surface, which faces the cam barrel 35, of the other end portion thereof extending to the side opposite to the passage 53. The other end portion of the link member 111 is biased by a push spring 115 mounted on the inner surface of the fixed ring 50, so that the friction member 96 comes into contact with the cam barrel 35 and is slightly pressed. The cam barrel 35 is joined to the zoom ring 23 as described above. Accordingly, torque required to rotate the zoom ring 23 is relatively large.

When the drive unit 1 is mounted on the lens barrel 20, the release member 12 of the drive unit 1 enters the lens barrel 20 through the passage 53 and pushes the other end portion of the link member 111. Accordingly, the friction member 96 is separated from the surface of the cam barrel 35 as shown by a chain line. Torque required to rotate the zoom ring 23 is reduced.

The zoom ring 23 has been described in the above-mentioned example. However, it goes without saying that the focus ring 22 or the iris ring 24 may be provided with the same torque adjustment mechanism, torque required to rotate the focus ring 22 or the iris ring 24 can be increased when the drive unit 1 is not mounted on the lens barrel 20, and torque required to rotate the focus ring 22 or the iris ring 24 can be reduced when the drive unit 1 is mounted on the lens barrel 20.

What is claimed is:

1. A lens system comprising:
a lens barrel on which an operation ring used to adjust an optical system provided in the lens barrel is rotatably provided; and
a drive unit that is detachably mounted on the lens barrel and rotates the operation ring when being mounted on the lens barrel,
wherein the lens barrel includes a lens barrel body in which the optical system is built, the operation ring that is provided on an outer peripheral side of the lens barrel body, a fixed ring that is disposed and fixed to the outer peripheral side of the lens barrel body and guides the rotation of the operation ring, and a torque adjustment mechanism that is provided in a space between an outer peripheral surface of the lens barrel body and a part of the operation ring and the fixed ring,
the torque adjustment mechanism includes a friction member, a holding member that is provided on the fixed ring and holds the friction member so that the friction member freely approaches or is freely separated from the operation ring or a member interlocking with the operation ring, and a biasing member that biases the friction member in a direction where the friction member comes into contact with the operation ring or the member interlocking with the operation ring,
a passage, which communicates with the torque adjustment mechanism from the outside, is formed in the fixed ring, and
the drive unit includes a release member that separates the friction member from the operation ring or the member interlocking with the operation ring by acting on the torque adjustment mechanism through the passage when the drive unit is mounted on the lens barrel.

2. The lens system according to claim 1,
wherein the release member acts on the holding member or the biasing member of the torque adjustment mechanism.

3. The lens system according to claim 1,
wherein the holding member and the biasing member are formed by one leaf spring.

4. The lens system according to claim 2,
wherein the holding member and the biasing member are formed by one leaf spring.

5. The lens system according to claim 1,
wherein the holding member is a link member of which a part is rotatably supported,
the friction member is provided at one end portion of the link member, and
the other portion of the link member is pulled or pushed by the biasing member, so that the friction member comes into contact with and presses the operation ring or the member interlocking with the operation ring.

6. The lens system according to claim 2,
wherein the holding member is a link member of which a part is rotatably supported,
the friction member is provided at one end portion of the link member, and
the other portion of the link member is pulled or pushed by the biasing member, so that the friction member comes into contact with and presses the operation ring or the member interlocking with the operation ring.

7. The lens system according to claim 1,
wherein the holding member and the biasing member are formed by a combination of a first support member that is fixed to the fixed ring, a rectangular parallelepiped elastic body that is fixed to the first support member, and a second support member that is fixed to the elastic body, and
the friction member is mounted on the second support member.

8. The lens system according to claim 2,
wherein the holding member and the biasing member are formed by a combination of a first support member that is fixed to the fixed ring, a rectangular parallelepiped elastic body that is fixed to the first support member, and a second support member that is fixed to the elastic body, and
the friction member is mounted on the second support member.

9. A lens barrel for use in the lens system according to claim 1, on which an operation ring used to adjust an optical system provided on the lens barrel is rotatably provided, the lens barrel comprising:
a lens barrel body in which the optical system is built;
the operation ring that is provided on an outer peripheral side of the lens barrel body;
a fixed ring that is disposed and fixed to the outer peripheral side of the lens barrel body and guides the rotation of the operation ring; and
a torque adjustment mechanism that is provided in a space between an outer peripheral surface of the lens barrel body and a part of the operation ring and the fixed ring,
wherein the torque adjustment mechanism includes a friction member, a holding member that is provided on the fixed ring and holds the friction member so that the friction member freely approaches or is freely separated from the operation ring or a member interlocking with the operation ring, and a biasing member that biases the friction member in a direction where the friction member comes into contact with the operation ring or the member interlocking with the operation ring, and
a passage, through which a release member provided on the drive unit acts on the torque adjustment mechanism when a drive unit is mounted on the lens barrel, is formed in the fixed ring.

10. The lens barrel according to claim 9,
wherein the release member acts on the holding member or the biasing member of the torque adjustment mechanism.

11. The lens barrel according to claim 9,
wherein the holding member and the biasing member are formed by one leaf spring.

12. The lens barrel according to claim 10,
wherein the holding member and the biasing member are formed by one leaf spring.

13. The lens barrel according to claim 9,
wherein the holding member is a link member of which a part is rotatably supported,
the friction member is provided at one end portion of the link member, and
the other portion of the link member is pulled or pushed by the biasing member, so that the friction member comes into contact with and presses the operation ring or the member interlocking with the operation ring.

14. The lens barrel according to claim 10,
wherein the holding member is a link member of which a part is rotatably supported,
the friction member is provided at one end portion of the link member, and
the other portion of the link member is pulled or pushed by the biasing member, so that the friction member comes into contact with and presses the operation ring or the member interlocking with the operation ring.

15. The lens barrel according to claim 9,
wherein the holding member and the biasing member are formed by a combination of a first support member that is fixed to the fixed ring, a rectangular parallelepiped elastic body that is fixed to the first support member, and a second support member that is fixed to the elastic body, and
the friction member is mounted on the second support member.

16. The lens barrel according to claim 10,
wherein the holding member and the biasing member are formed by a combination of a first support member that is fixed to the fixed ring, a rectangular parallelepiped elastic body that is fixed to the first support member, and a second support member that is fixed to the elastic body, and
the friction member is mounted on the second support member.

17. A drive unit that is detachably mounted on the lens barrel according to claim 9, the drive unit comprising:
a drive that rotates the operation ring when the drive unit is mounted on the lens barrel; and
the release member that acts on the torque adjustment mechanism through the passage.

18. A drive unit for use in the lens system according to claim 1, which drive unit is detachably mounted on a lens barrel on which an operation ring used to adjust an optical system provided in the lens barrel is rotatably provided, the drive unit comprising:
a drive that rotates the operation ring when the drive unit is mounted on the lens barrel; and
a member that releases a frictional force applied to the operation ring or a member interlocking with the operation ring by acting on a mechanism, the mechanism mounted on the lens barrel and adjusting torque of the operation ring.
